(19) United States
(12) Patent Application Publication
(10) Pub. No.: US 2026/0119173 A1
(43) Pub. Date: Apr. 30, 2026

(54) GATHER OPERATION USING A COMMON REGISTER FILE ENTRY AS DESTINATION REGISTER FOR ALL LOAD SUBOPERATIONS

(71) Applicant: Ampere Computing LLC, Santa Clara, CA (US)

(72) Inventors: Willard S. BRIGGS, Boulder, CO (US); Mark CHARNEY, Lexington, MA (US); Abitha PANNEERSELVAM, Hillsboro, OR (US); Thomas SCHWABEL, Portland, OR (US); Bret TOLL, Hillsboro, OR (US)

(21) Appl. No.: 18/933,952

(22) Filed: Oct. 31, 2024

(51) Int. Cl. G06F 9/30

(52) U.S. Cl. CPC G06F 9/30043; G06F 9/30036

(57) ABSTRACT

Disclosed are techniques for performing a gather operation using one register file entry as the destination for all of the load suboperations. In an aspect, a method of performing a gather operation using one register file entry comprises detecting a gather operation comprising a plurality of load suboperations accessing independent, possibly disjoint memory locations, performing the plurality of load suboperations, wherein each load suboperation writes to a different portion of the one register file entry without overwriting the other portions of the one register file entry. The method further includes determining that all of the plurality of load suboperations have been completed, and upon determining that all of the plurality of load suboperations have been completed, making the one register file entry available for a read operation.

### BACKGROUND

### I. Field of the Disclosure

Aspects of the disclosure relate generally to the hardware optimization of instruction execution by a processor.

### II. Background

Gather operations typically involve several load suboperations accessing independent memory locations. The data from each load suboperation is herein referred to as a “chunk”, and each load suboperation returns its own chunk. Those load suboperations ultimately store the results of those memory accesses into one destination register, called a vector register. Thus, a gather operation can be said to be gathering a set of chunks into a vector register.

Typical high performance general purpose microarchitectures only allow for one writer of a vector register at a time, and the vector register must be written to all at once-i.e., it is not possible to fill the vector register by, for example, writing to the bottom half of the vector register and then later writing to the top half of the same vector register, because every write to a vector register overwrites all of the vector register's bits.

Because of this, the load sub operation addresses are typically generated using a general purpose register or are immediate-encoded in the instruction encoding along with a source vector register, and processors that support OOO load suboperations conventionally store each “chunk” in separate registers, which are then “merged” with each other in yet another register, before being written to the destination register. Since gather operations require multiple suboperations to modify one destination register, in arbitrary order, special tracking is required to determine when all the load suboperations are completed. Thus, gather operations typically consume many register resources and require a high level of tracking overhead.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method for performing a gather operation using one vector or non-vector register file entry as the destination for all of the load suboperations includes detecting a gather operation comprising a plurality of load suboperations accessing independent, possibly disjoint memory locations, performing the plurality of load suboperations, each load suboperation writing to a different portion of the one register file entry without overwriting the other portions of the one register file entry, determining that all of the plurality of load suboperations have been completed, and upon determining that all of the plurality of load suboperations have been completed, making the one register file entry available for a read operation.

In an aspect, an apparatus for performing a gather operation using one vector or non-vector register file entry as the destination for all of the load suboperations comprises a register file comprising at least one register file entry, and processing circuitry. The processing circuitry is configured to detect a gather operation comprising a plurality of load suboperations accessing independent, possibly disjoint memory locations, perform the plurality of load suboperations, each load suboperation writing to a different portion of the one register file entry without overwriting the other portions of the one register file entry, determine that all of the plurality of load suboperations have been completed, and upon determining that all of the plurality of load suboperations have been completed, make the one register file entry available for a read operation.

In an aspect, an apparatus for performing a gather operation using one vector or non-vector register file entry as the destination for all of the load suboperations, the apparatus comprising a register file means comprising at least one register file entry, a first processing means for detecting a gather operation comprising a plurality of load suboperations accessing independent, possibly disjoint memory locations, a second processing means for performing the plurality of load suboperations, each load suboperation writing to a different portion of the one register file entry without overwriting the other portions of the one register file entry, a third processing means for determining that all of the plurality of load suboperations have been completed, and upon determining that all of the plurality of load suboperations have been completed, making the one register file entry available for a read operation.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 is a block diagram of a many-core system on a chip (SoC) that supports performing a gather operation using one register file entry as the destination for all of the load suboperations, according to aspects of the disclosure;

FIG. 2 is a block diagram of a core that supports performing a gather operation using one register file entry as the destination for all of the load suboperations, according to aspects of the disclosure;

FIG. 3 is a flow chart illustrating an example process associated with performing a gather operation using one register file entry as the destination for all of the load suboperations, according to aspects of the disclosure; and

FIG. 4 and FIG. 5 are block diagrams showing a register file in more detail according to aspects of the disclosure.

### DETAILED DESCRIPTION OF THE DRAWINGS

Disclosed are techniques for performing a gather operation using one vector or non-vector register file entry as the destination for all of the load suboperations. In an aspect, a method or performing a gather operation using one register file entry comprises detecting a gather operation comprising a plurality of load suboperations accessing independent, possibly disjoint memory locations, performing the plurality of load suboperations, each load suboperation writing to a different portion of the one register file entry without overwriting the other portions of the one register file entry, determining that all of the plurality of load suboperations have been completed, and upon determining that all of the plurality of load suboperations have been completed, making the one register file entry available for a read operation.

Advantages of the subject matter disclosed herein include at least the following. Gathering chunks into a single register, rather than storing individual chunks into different registers that must later be merged together as done in the prior art, reduces the number of physical registers that must be consumed, which increases power efficiency, and reduces register bottlenecks that might otherwise stall a process. It also allows for more effective use of the existing registers, which may enable implementations to have fewer registers overall. The ability to write multiple times to one register file entry and to track the completion of the final write before making the final register value available for subsequent consumers enables a scalable solution that supports a large number of concurrent gather operations composed from a large number of concurrent load suboperations. Conventional methods use a limited number of finite state machines to launch, track and reassemble the load suboperation results. Such approaches unnecessarily limit the number of concurrent gather operations or incur an overly burdensome cost that is prohibitive for most designs. In contrast, the techniques presented herein directly store the partial results in a single register file entry, which reduces the costs to the theoretical minimum.

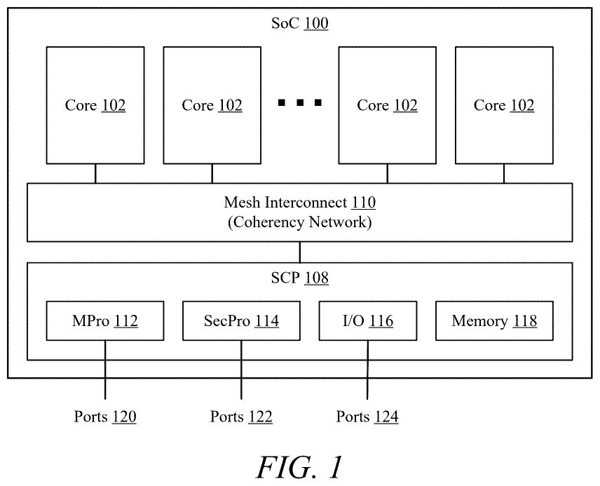

FIG. 1 is a diagram of a many-core system on a chip (SoC) 100 that supports performing a gather operation using one vector or non-vector register file entry as the destination for all of the load suboperations, according to aspects of the disclosure. The SoC 100 illustrated in FIG. 1 includes a set of processing cores 102 (or simply “cores” 102). The SoC 100 also includes a system control processor (SCP) 108 that handles many of the system management functions of the SoC 100. The cores 102 are connected to the SCP 108 via a mesh interconnect 110 that forms a high-speed bus that couples each of core 102 to the other cores 102 and to other on chip and off-chip resources, including higher levels of memory (e.g., a level three (L3) cache, dual data rate (DDR) memory), peripheral component interconnect express (PCIe) interfaces, and/or other resources.

The SCP 108 may include a variety of system management functions, which may be divided across multiple functional blocks or which may be contained in a single functional block. In the example illustrated in FIG. 1, the system management functions of the SCP 108 are divided between a management processor (MPro) 112 and a security processor (SecPro) 114 coupled to other components of the SoC 100 by the mesh interconnect 110. The SoC 100, the MPro 112, and the SecPro 114 may each include joint test action group (JTAG) ports and firmware, which may be connected to other components within the SoC 100 via the mesh interconnect 110, an inter-integrated circuit (I2C) interface, or other connection. In the example illustrated in FIG. 1, the SCP 108 further includes an input/output (I/O) block 116 and a shared memory 118 also coupled to other components of the SoC 100 by the mesh interconnect 110. Note that although FIG. 1 illustrates the MPro 112 and the SecPro 114 as separate microcontrollers (or processors), as will be appreciated, they may be combined into one or two microcontrollers, or sub-divided into more than two microcontrollers.

The MPro 112 and the SecPro 114 may include a bootstrap controller and an I2C controller or other bus controller. The MPro 112 and the SecPro 114 may communicate with on-chip sensors, an off-chip baseboard management controller (BMC), and/or other external systems to provide control signals to external systems. The MPro 112 and the SecPro 114 may connect to one or more off-chip systems as well via ports 120 and ports 122, respectively, and/or may connect to off-chip systems via the I/O block 116, e.g., via ports 124.

The MPro 112 performs error handling and crash recovery for the cores 102 of the SoC 100 and performs power management, power failure detection, recovery, and other fail safes for the SoC 100. The MPro 112 may also report power conditions and throttling to an operating system (OS) or hypervisor running on the SoC 100. The MPro 112 may connect to the shared memory 118, the SecPro 114, and external systems (e.g., VRs) via ports 120, and may supply power to each via power lines.

The SecPro 114 manages the boot process and performs security sensitive operations and only runs authenticated firmware. More specifically, the components of the SoC 100 may be divided into trusted components and non-trusted components, where the trusted components may be verified by certificates in the case of software and firmware components, or may be pure hardware components, so that at boot time, the SecPro 114 may ensure that the boot process is secure.

The I/O block 116 may connect over ports 124 to external systems and memory (not shown) and connect to the shared memory 118. The SCP 108 may use the I/O connections of the I/O block 116 to interface with a BMC or other management system(s) for the SoC 100 and/or to the network of the cloud platform (e.g., via gigabit ethernet, PCIe, or fiber). The SCP 108 may perform scaling, balancing, throttling, and other control processes to manage the cores 102, associated memory controllers, and mesh interconnect 110 of the SoC 100.

In some aspects, the mesh interconnect 110 is part of a coherency network. There are points of coherency somewhere in the mesh network depending on the address and target memory. A coherency network typically includes control registers, status registers, and state machines, and in the example illustrated in FIG. 1, these are initialized by the MPro 112, e.g., based on system and memory configuration, and the MPro 112 monitors the coherency domain for errors.

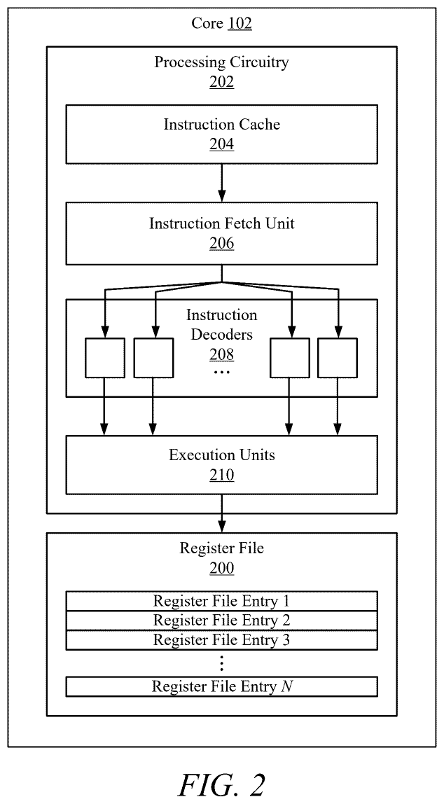

FIG. 2 is a simplified block diagram of a core 102, according to aspects of the disclosure. In the example shown in FIG. 2, the core 102 includes a vector or non-vector register file 200 comprising at least one register file entry-in the example shown in FIG. 2, the register file 200 includes register file entries 1 through N-and processing circuitry 202. All bits of the register file entries may be written to at the same time, or portions of the register file entries-referred to as “chunks” may be written to separately. For example, a 64-bit vector register may be divided into four separate 16-bit chunks, eight separate 8-bit chunks, two different 32-bit chunks, etc., according to a specific hardware implementation. In the examples below, the register file entries are shown as having four chunks, and thus supporting up to four load suboperations, but other numbers of chunks are also contemplated by the instant disclosure.

The processing circuitry 202 is configured to detect a gather operation comprising a plurality of load suboperations accessing independent, possibly disjoint memory locations. For each gather operation, the load suboperation knows (1) what memory to access and how many bytes, (2) what portion (chunk) of the destination register to write to and (3) how many load suboperations there are for the particular gather operation. The processing circuitry 202 is further configured to perform the plurality of load suboperations, each load suboperation writing to a different portion of the one register file entry without overwriting the other portions of the one register file entry. In some aspects, the load suboperations may proceed in parallel through a memory system that supports multiple concurrent load suboperations without burdensome tracking or storage in the load-store unit (LSU).

The processing circuitry 202 is further configured to determine that all of the plurality of load suboperations have been completed, and, upon determining that all of the plurality of load suboperations have been completed, make the one register file entry available for a read operation.

In some aspects, such as the example shown in FIG. 2, the processing circuitry 202 may comprise an instruction cache 204 for storing processor instructions (e.g., macro-operations), an instruction fetch unit 206 for fetching the instructions from the instruction cache 204 and assign them to instruction decoders 208. The instruction decoders 208 translate the macro-operations into one or more micro-operations that are natively executed by the execution units 210.

In some aspects, the instruction fetch unit 206 is configured to detect the gather operation comprising a plurality of load suboperations accessing independent, possibly disjoint memory locations and to assign the gather operation or the plurality of load suboperations to the same instruction decoder 208.

In some aspects, the instruction decoder 208 is configured to detect the gather operation comprising a plurality of load suboperations accessing independent, possibly disjoint memory locations and assign the gather operation or the plurality of load suboperations to the same execution unit 210.

In some aspects, the execution unit 210 is configured to detect the gather operation comprising a plurality of load suboperations accessing independent, possibly disjoint memory locations and select, from the register file 200, the register file entry (which may also be referred to herein as a “register”) that will be the one register that will have different portions that are overwritten by each of the plurality of load suboperations without overwriting the other portions of that register.

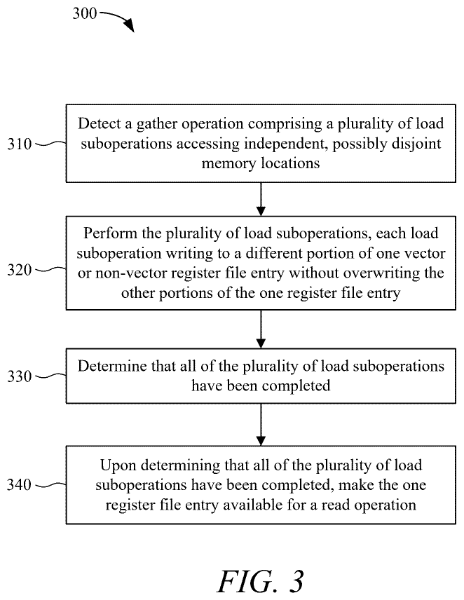

FIG. 3 is a flow chart illustrating a process 300 for performing a gather operation using one register file entry as the destination for all of the load suboperations, according to aspects of the disclosure. In some implementations, one or more process blocks of FIG. 3 may be performed by a processor (e.g., processor core 102). In some implementations, one or more process blocks of FIG. 3 may be performed by another device or a group of devices separate from or including the processor. Additionally, or alternatively, one or more process blocks of FIG. 3 may be performed by one or more components of a processor, such as an instruction cache 204, an instruction fetch unit 206, instruction decoder(s) 208, execution unit(s) 210, or register file 200.

As shown in FIG. 3, process 300 may include, at block 310, detecting a gather operation comprising a plurality of load suboperations that access independent, possibly disjoint memory locations and that store the data into a common destination register. Means for performing the operations of block 310 may include a component of the processing circuitry 202. For example, a gather operation comprising a plurality of load suboperations accessing independent, possibly disjoint memory locations may be detected by the instruction cache 204, the instruction fetch unit 206, the instruction decoders 208, and/or the execution units 210.

As further shown in FIG. 3, process 300 may include, at block 320, performing the plurality of load suboperations, each load suboperation writing to a different portion of the one register file entry without overwriting the other portions of the one register file entry. In some aspects, performing the plurality of load suboperations comprises performing the load suboperations without enforcing an order on the plurality of load suboperations, including performing the load suboperations simultaneously. Means for performing the operations of block 320 may include a component of the processing circuitry 202. For example, the plurality of load suboperations may be performed by one or more of the execution units 210, which may select one of the register file entries in the register file 200 as the target of the plurality of load suboperations.

As further shown in FIG. 3, process 300 may include, at block 330, determining that all of the plurality of load suboperations have been completed. Means for performing the operations of block 330 may include a component of the processing circuitry 202. For example, the execution units 210 may determine that all of the plurality of load suboperations have been completed.

As further shown in FIG. 3, process 300 may include, at block 340, upon determining that all of the plurality of load suboperations have been completed, making the one register file entry available for a read operation. Means for performing the operations of block 340 may include a component of the processing circuitry 202. For example, the execution units 210 may make the selected register file entry in the register file 200 available for a read operation, e.g., by setting a status bit or other means.

In some aspects, performing the plurality of load suboperations comprises, for each load suboperation, setting a hardware indicator for the portion of the one register file entry that has been written to by the respective load suboperation. In some aspects, determining that all of the plurality of load suboperations have been completed comprises determining that the hardware indicators for all portions of the one register file entry have been set. In some aspects, setting the hardware indicator for the portion of the one register file entry that has been written to by the respective load suboperation comprises setting a bit in a bitfield for each portion of the one register file entry that has been written to by the respective load suboperation.

In some aspects, performing the plurality of load suboperations comprises, for each load suboperation, incrementing a counter. In some aspects, determining that all of the plurality of load suboperations have been completed comprises determining that the counter value has reached a value indicating that all of the plurality of load suboperations have been completed.

In some aspects, the plurality of load suboperations will completely fill the one register file entry. In some aspects, the plurality of load suboperations will not completely fill the one register file entry.

In some aspects, the one register file entry comprises a vector register file entry. In some aspects, the one register file entry comprises a non-vector register file entry.

Process 300 may include additional implementations, such as any single implementation or any combination of implementations described below and/or in connection with one or more other processes described elsewhere herein. Although FIG. 3 shows example blocks of process 300, in some implementations, process 300 may include additional blocks, fewer blocks, different blocks, or differently arranged blocks than those depicted in FIG. 3. Additionally, or alternatively, two or more of the blocks of process 300 may be performed in parallel.

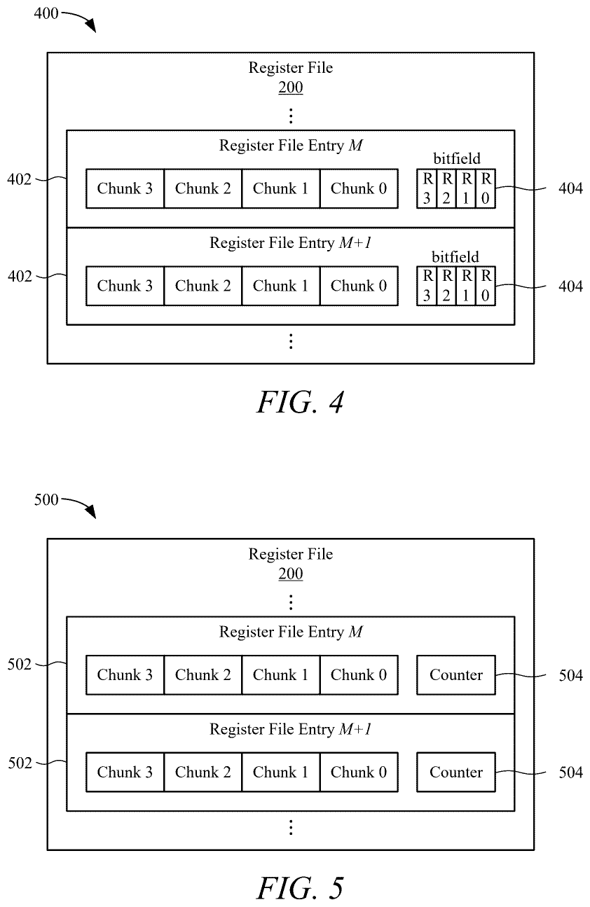

FIG. 4 is a block diagram 400 showing a register file 200 in more detail according to aspects of the disclosure. In the example shown in FIG. 4, the register file 200 include a plurality of register file entries 402. Each register file entry 402 comprises a plurality of chunks. In the example shown in FIG. 4, each register file entry 402 is divided into four chunks labeled “Chunk 0” through “Chunk 3,” but in other embodiments the register file entry 402 may be divided into a greater or lesser number of chunks. In the example shown in FIG. 4, each register file entry 402 includes a bitfield 404, where each bit in the bitfield corresponds to one of the chunks. In the example shown in FIG. 4, the bitfield 404 has four bits, each bit indicates whether the corresponding chunk is “ready”, i.e., that the load suboperation that targets that chunk has completed, and thus are labeled “R0” through “R3.” In some aspects, when a register file entry 402 is the target of a plurality of load suboperations, then that register file entry 402 may be made write-only, i.e., a read from that register file entry 402 is prohibited. In some aspects, when a chunk is to be a target of one of the plurality of load suboperations, the ready bit for that chunk is cleared, and when that chunk is written to by a load suboperation, then the ready bit for that chunk is set. In some aspects, if that chunk is not to be a target of one of the plurality of load suboperations, then the ready bit for that chunk is preset, (set in advance), so that when the chunks that are to be targets of a load operation have been written to and their respective ready bits have been set, then all of the ready bits are indicated as being set. Once all of the bits in the bitfield 404 are set, then this is an indication that the plurality of load suboperations is complete and that particular register file entry 402 may be made available for a read operation.

FIG. 5 is a block diagram 500 showing a register file 200 in more detail according to aspects of the disclosure. In the example shown in FIG. 5, the register file 200 include a plurality of register file entries 502. Each register file entry 502 comprises a plurality of chunks. In the example shown in FIG. 5, each register file entry 502 is divided into four chunks labeled “Chunk 0” through “Chunk 3,” but in other embodiments the register file entry 502 may be divided into a greater or lesser number of chunks. In the example shown in FIG. 5, each register file entry 502 includes a counter 504, which is incremented each time a chunk is written to by a load suboperation that targets that chunk.

In some aspects, when a register file entry 502 is the target of a plurality of load suboperations, then that register file entry 502 may be made write-only, i.e., a read from that register file entry 502 is prohibited. In some aspects, when all of the chunks are to be targets of the plurality of load suboperations, the value of the counter 504 may be set to zero, and when that chunk is written to by a load suboperation, then counter value is incremented. In some aspects, if one or more chunks are not to be a target of one of the plurality of load suboperations, then the counter can be pre-incremented by one for each of those one or more chunks. Once the counter 504 reaches a count equal to the number of chunks in the register file entry 502, then this is an indication that the plurality of load suboperations is complete and that particular register file entry 502 may be made available for a read operation.

Likewise, in some aspects, the counter 504 may be preloaded with a value equal to the number of chunks in the register file entry 502, and decremented each time a chunk has been written to successfully. When the counter value reaches zero, then this is an indication that the plurality of load suboperations is complete and that particular register file entry 502 may be made available for a read operation. In some aspects, if one or more chunks are not to be a target of one of the plurality of load suboperations, then the counter can be pre-decremented by one for each of those one or more chunks.

In some aspects, the processing circuitry 202 is configured to support sign-extension and zero-extension of the data that is being loaded to the chunk size of the register file entry. In some aspects, the processing circuitry 202 is configured to perform rounding, scaling, or saturation operations on the loaded data. In some aspects, the processing circuitry 202 is configured to perform logical or arithmetic operations on the loaded data. In some aspects, the processing circuitry 202 is configured to adhere to memory ordering semantics relative to other loads and stores.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

It will be understood that the specific implementations described herein are illustrative and not limiting. The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein but is to be accorded the widest scope consistent with the principles and novel features disclosed herein.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art.

Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill in the art will further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a DSP, an ASIC, an FPGA, or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

Furthermore, as used herein, the terms “set,” “group,” and the like are intended to include one or more of the stated elements. Also, as used herein, the terms “has,” “have,” “having,” “comprises,” “comprising,” “includes,” “including,” and the like does not preclude the presence of one or more additional elements (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”) or the alternatives are mutually exclusive (e.g., “one or more” should not be interpreted as “one and more”). Furthermore, although components, functions, actions, and instructions may be described or claimed in the singular, the plural is contemplated unless limitation to the singular is explicitly stated. Accordingly, as used herein, the articles “a,” “an,” “the,” and “said” are intended to include one or more of the stated elements. Additionally, as used herein, the terms “at least one” and “one or more” encompass “one” component, function, action, or instruction performing or capable of performing a described or claimed functionality and also “two or more” components, functions, actions, or instructions performing or capable of performing a described or claimed functionality in combination.

1. A method for performing a gather operation using one register file entry as a destination for all load suboperations of the gather operation, the method comprising:
detecting a gather operation comprising a plurality of load suboperations accessing independent memory locations;
performing the plurality of load suboperations, each of the plurality of load suboperations writing to a different portion of the one register file entry without overwriting the other portions of the one register file entry;
determining that all of the plurality of load suboperations have been completed; and
upon determining that all of the plurality of load suboperations have been completed, making the one register file entry available for a read operation.

2. The method of claim 1,
wherein performing the plurality of load suboperations comprises, for each load suboperation of the plurality of load suboperations, setting a hardware indicator for the portion of the one register file entry that has been written to by the respective load suboperation, and
wherein determining that all of the plurality of load suboperations have been completed comprises determining that the hardware indicators for all portions of the one register file entry have been set.

3. The method of claim 2, wherein setting the hardware indicator for the portion of the one register file entry that has been written to by the respective load suboperation comprises setting a bit in a bitfield for each portion of the one register file entry that has been written to by the respective load suboperation.

4. The method of claim 1,
wherein performing the plurality of load suboperations comprises, for each load suboperation, incrementing a counter, and
wherein determining that all of the plurality of load suboperations have been completed comprises determining that a value of the counter has reached a value indicating that all of the plurality of load suboperations have been completed.

5. The method of claim 1, wherein the plurality of load suboperations accessing independent memory locations will completely fill the one register file entry.

6. The method of claim 1, wherein the plurality of load suboperations accessing independent memory locations will not completely fill the one register file entry.

7. The method of claim 1, wherein performing the plurality of load suboperations comprises performing the plurality of load suboperations in any order.

8. The method of claim 1, wherein the one register file entry comprises a vector register file entry.

9. The method of claim 1, wherein the one register file entry comprises a non-vector register file entry.

10. An apparatus for performing a gather operation using one register file entry as a destination for all load suboperations of the gather operation, the apparatus comprising:
a register file comprising a plurality of register file entries; and
processing circuitry configured to:
detect a gather operation comprising a plurality of load suboperations accessing independent memory locations;
perform the plurality of load suboperations, each load suboperation of the plurality of load suboperations writing to a different portion of one register file entry of the plurality of register file entries without overwriting the other portions of the one register file entry;
determine that all of the plurality of load suboperations have been completed; and
upon determining that all of the plurality of load suboperations have been completed, make the one register file entry available for a read operation.

11. The apparatus of claim 10,
wherein, to perform the plurality of load suboperations the processing circuitry is configured to, for each load suboperation of the plurality of load suboperations, set a hardware indicator for the portion of the one register file entry that has been written to by the respective load suboperation, and
wherein, to determine that all of the plurality of load suboperations have been completed, the processing circuitry is configured to determine that the hardware indicators for all portions of the one register file entry have been set.

12. The apparatus of claim 11, wherein, to set the hardware indicator for the portion of the one register file entry that has been written to by the respective load suboperation, the processing circuitry is configured to set a bit in a bitfield for each portion of the one register file entry that has been written to by the respective load suboperation.

13. The apparatus of claim 10,
wherein, to perform the plurality of load suboperations, the processing circuitry is configured to, for each load suboperation, increment a counter, and
wherein, to determine that all of the plurality of load suboperations have been completed, the processing circuitry is configured to determine that a value of the counter has reached a value indicating that all of the plurality of load suboperations have been completed.

14. The apparatus of claim 10, wherein the plurality of load suboperations accessing independent memory locations will completely fill the one register file entry.

15. The apparatus of claim 10, wherein the plurality of load suboperations accessing independent memory locations will not completely fill the one register file entry.

16. The apparatus of claim 10, wherein, to perform the plurality of load suboperations, the processing circuitry is configured to perform the plurality of load suboperations in any order.

17. The apparatus of claim 10, wherein the one register file entry comprises a vector register file entry.

18. The apparatus of claim 10, wherein the one register file entry comprises a non-vector register file entry.

19. (canceled)

20. A method for performing a gather operation using one register file entry as a destination for all load suboperations of the gather operation, the method comprising:
detecting a gather operation comprising a plurality of load suboperations accessing independent memory locations;
performing the plurality of load suboperations, each of the plurality of load suboperations writing to a different portion of the one register file entry without overwriting the other portions of the one register file entry, wherein performing the plurality of load suboperations comprises, for each load suboperation, incrementing a counter;
determining that all of the plurality of load suboperations have been completed, wherein determining that all of the plurality of load suboperations have been completed comprises determining that a value of the counter has reached a value indicating that all of the plurality of load suboperations have been completed; and
upon determining that all of the plurality of load suboperations have been completed, making the one register file entry available for a read operation.
